(19) United States
(12) Patent Application Publication
(10) Pub. No.: US 2021/0396541 A1
(43) Pub. Date: Dec. 23, 2021

(54) FLOOD DISPLAY DEVICE, FLOOD DETECTION DEVICE, SERVER, FLOOD DISPLAY SYSTEM, FLOOD DISPLAY METHOD, FLOOD DETECTION METHOD, AND RECORDING MEDIUM

(71) Applicant: TOYOTA JIDOSHA KABUSHIKI KAISHA, Toyota-shi (JP)

(72) Inventors: Naoki ISHIHARA, Chiyoda-ku (JP); Takayuki YAMABE, Chiyoda-ku (JP); Tetsuya HASHIMOTO, Chiyoda-ku (JP); Hajime TOJIKI, Chiyoda-ku (JP)

(73) Assignee: TOYOTA JIDOSHA KABUSHIKI KAISHA, Toyota-shi (JP)

(21) Appl. No.: 17/304,394

(22) Filed: Jun. 21, 2021

(30) Foreign Application Priority Data
Jun. 22, 2020 (JP) 2020-107345

(51) Int. Cl. G01C 21/36

(52) U.S. Cl. CPC G01C 21/3694; G01C 21/3667

(57) ABSTRACT

A flood display device includes: a processor with hardware, the processor being provided to: acquire flood point information in which a detection result of a flood point of a road and a classification of a flood situation at the flood point determined based on traveling state data of a vehicle traveling at the detected flood point are associated with each other based on the traveling state data related to the traveling of the vehicle, generate flood detection information in which a display mode of the detection result is changed based on the classification of the flood situation as flood detection information obtained by superimposing the detection result on a position on a map corresponding to the flood point based on the flood point information, and output the flood detection information to a display.

### CROSS-REFERENCE TO RELATED APPLICATION(S)

The present application claims priority to and incorporates by reference the entire contents of Japanese Patent Application No. 2020-107345 filed in Japan on Jun. 22, 2020.

### BACKGROUND

The present disclosure relates to a flood display device, a flood detection device, a server, a flood display system, a flood display method, a flood detection method, and a recording medium.

In Japanese Laid-open Patent Publication No. 2021-043910, a technology for displaying a detection result of detecting a flooded point of a road using a detection result of detecting a flood of the road on which a vehicle travels, and weather information including at least one of rainfall information representing actual rainfall information in an area where the vehicle travels and rainfall prediction information representing a predicted amount of rainfall is known. In this technology, the detection result of detecting the flood of the road is displayed on a map of a flood application displayed on a mobile phone or the like owned by a user.

### SUMMARY

There is a need for providing a flood display device, a flood detection device, a server, a flood display system, a flood display method, a flood detection method, and a recording medium that are more convenient for the user.

According to an embodiment, a flood display device includes: a processor with hardware, the processor being provided to: acquire flood point information in which a detection result of a flood point of a road and a classification of a flood situation at the flood point determined based on traveling state data of a vehicle traveling at the detected flood point are associated with each other based on the traveling state data related to the traveling of the vehicle, generate flood detection information in which a display mode of the detection result is changed based on the classification of the flood situation as flood detection information obtained by superimposing the detection result on a position on a map corresponding to the flood point based on the flood point information, and output the flood detection information to a display.

According to an embodiment, a flood detection device includes: a processor with hardware, the processor being provided to: acquire traveling state data related to a traveling of a vehicle, detect whether a flood point has occurred on a road based on the traveling state data, and determine a classification of a flood situation in the detected flood point based on the traveling state data of the vehicle traveling on the detected flood point.

According to an embodiment, a server includes: a processor with hardware, the processor being provided to: acquire flood point information in which a detection result of a flood point of a road and a classification of a flood situation at the flood point determined based on traveling state data of a vehicle traveling at the detected flood point are associated with each other based on the traveling state data related to the traveling of the vehicle, generate flood detection information in which a display mode of the detection result is changed based on the classification of the flood situation as flood detection information obtained by superimposing the detection result on a position on a map corresponding to the flood point based on the flood point information, and transmit the flood detection information to an external device.

According to an embodiment, a flood display system includes: a flood detection device including a first processor with hardware; a server including a second processor with hardware; and a flood display device including a third processor with hardware, the first processor being provided to: acquire traveling state data related to a traveling of a vehicle, detect whether a flood point has occurred on a road based on the traveling state data, and determine a classification of a flood situation at the detected flood point based on the traveling state data of the vehicle traveling on the detected flood point, the second processor being provided to: acquire flood point information in which a detection result of the flood point and the classification of the flood situation are associated with each other, and generate flood detection information in which a display mode of the detection result is changed based on the classification of the flood situation as the flood detection information in which the detection result is superimposed on a position on a map corresponding to the flood point, based on the flood point information, and the third processor being provided to: acquire the flood detection information, and output the flood detection information to a display.

According to an embodiment, a flood display method executed by a flood display device including a processor with hardware, the flood display method including: acquiring, by the processor, flood point information in which a detection result of a flood point of a road and a classification of a flood situation determined based on traveling state data of a vehicle traveling at the detected flood point are associated with each other based on the traveling state data related to the traveling of the vehicle; generating, by the processor, flood detection information in which a display mode of the detection result is changed based on the classification of the flood situation as flood detection information obtained by superimposing the detection result on a position on a map corresponding to the flood point based on the flood point information; and outputting, by the processor, the flood detection information to a display.

According to an embodiment, a flood display method executed by a server including a processor with hardware, the flood display method including: acquiring, by the processor, flood point information in which a detection result of a flood point of a road and a classification of a flood situation at the flood point determined based on traveling state data of a vehicle traveling at the detected flood point are associated with each other based on the traveling state data related to the traveling of the vehicle; generating, by the processor, flood detection information in which a display mode of the detection result is changed based on the classification of the flood situation as flood detection information obtained by superimposing the detection result on a position on a map corresponding to the flood point based on the flood point information; and transmitting, by the processor, the flood detection information to an external device.

According to an embodiment, a flood detection method executed by a flood detection device including a processor with hardware, the flood detection method comprising: acquiring, by the processor, traveling state data related to a traveling of a vehicle; detecting, by the processor, whether a flood point has occurred on a road based on the traveling state data; and determining, by the processor, a classification of a flood situation in the detected flood point based on the traveling state data of the vehicle traveling on the detected flood point.

According to an embodiment, a non-transitory computer-readable recording medium storing a program for causing a processor with hardware to: acquire flood point information in which a detection result of a flood point of a road and a classification of a flood situation at the flood point determined based on traveling state data of a vehicle traveling at the detected flood point are associated with each other based on the traveling state data related to the traveling of the vehicle; generate flood detection information in which a display mode of the detection result is changed based on the classification of the flood situation as flood detection information obtained by superimposing the detection result on a position on a map corresponding to the flood point based on the flood point information; and output the flood detection information to a display.

According to an embodiment, a non-transitory computer-readable recording medium storing a program for causing a processor with hardware to: acquire flood point information in which a detection result of a flood point of a road and a classification of a flood situation at the flood point determined based on traveling state data of a vehicle traveling at the detected flood point are associated with each other based on the traveling state data related to the traveling of the vehicle; generate flood detection information in which a display mode of the detection result is changed based on the classification of the flood situation as flood detection information obtained by superimposing the detection result on a position on a map corresponding to the flood point based on the flood point information; and transmit the flood detection information to an external device.

According to an embodiment, a non-transitory computer-readable recording medium storing a program for causing a processor with hardware to: acquire traveling state data related to a traveling of a vehicle; detect whether a flood point has occurred on a road based on the traveling state data; and determine a classification of a flood situation in the detected flood point based on the traveling state data of the vehicle traveling on the detected flood point.

### BRIEF DESCRIPTION OF THE DRAWINGS

FIG. 1 is a diagram schematically illustrating a configuration of a flood display system according to a first embodiment;

FIG. 2 is a block diagram illustrating a functional configuration of a vehicle according to the first embodiment;

FIG. 3 is a block diagram illustrating a functional configuration of a flood detection device according to the first embodiment;

FIG. 4 is a diagram illustrating an example of flood point information according to the first embodiment;

FIG. 5 is a block diagram illustrating a functional configuration of a map device according to the first embodiment;

FIG. 6 is a block diagram illustrating a functional configuration of a flood display device according to the first embodiment;

FIG. 7 is a flowchart illustrating an outline of processing executed by the flood display system according to the first embodiment;

FIG. 8 is a diagram schematically illustrating a flood point;

FIG. 9 is a diagram schematically illustrating an actually measured speed of a vehicle and a predicted speed predicted by a prediction unit at the flood point of FIG. 8;

FIG. 10 is a diagram schematically illustrating an actually measured speed of a vehicle and a predicted speed predicted by a prediction unit at the flood point of FIG. 8;

FIG. 11 is a diagram illustrating an example of flood detection information displayed by a flood display device 40;

FIG. 12 is a diagram schematically illustrating a method of determining a classification of a flood situation at a flood point determined by a determination unit according to a second embodiment;

FIG. 13 is a diagram schematically illustrating an actually measured speed of a vehicle and a predicted speed predicted by a prediction unit in a predetermined divided region according to a third embodiment;

FIG. 14 is a diagram schematically illustrating a determination method in which a determination unit determines in the third embodiment; and

FIG. 15 is a diagram schematically illustrating a configuration of a flood display system according to a fourth embodiment.

### DETAILED DESCRIPTION

In the related art, for example, in Japanese Laid-open Patent Publication No. 2021-043910, since the detection result is uniformly displayed on the map of the flood application regardless of a flood situation of the flood point of the road, it was difficult for the user to grasp the flood situation of the flood point in detail, and there was room for improvement in terms of usability.

Hereinafter, a flood display system according to an embodiment of the present disclosure will be described with reference to the drawings. Note that the present disclosure is not limited to the following embodiments. In addition, in the following, the same portions will be described with the same reference numerals.

### First Embodiment

Overview of Flood Display System

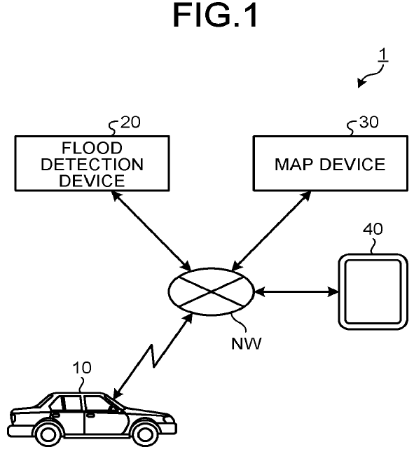

FIG. 1 is a diagram schematically illustrating a configuration of a flood display system according to a first embodiment. A flood display system 1 illustrated in FIG. 1 includes a vehicle 10, a flood detection device 20, a map device 30, and a flood display device 40. The flood display system 1 is configured to be able to communicate with each other through the network NW. This network NW is configured with, for example, an Internet network, a mobile phone network, and the like. In addition, the flood display system 1 transmits controller area network (CAN) data including driving state data related to the driving of the vehicle 10 transmitted by each of a plurality of vehicles 10 at predetermined intervals (for example, 10 msec intervals) to the flood detection device 20 through the network NW. Then, in the flood display system 1, the flood detection device 20 determines a flood of a road for each of a plurality of divided regions (for example, 16 m×16 m) divided based on latitude and longitude, and detects the flood of the road, based on the CAN data transmitted by each of the plurality of vehicles 10 at the predetermined intervals. Thereafter, in the flood display system 1, the map device 30 or the flood display device 40 such as a mobile phone or a tablet terminal outputs flood detection information in which a detection result of a flood point is superimposed on a position on the map corresponding to the flood point of the road based on the detection result of the flood detection device 20.

Configuration of Vehicle

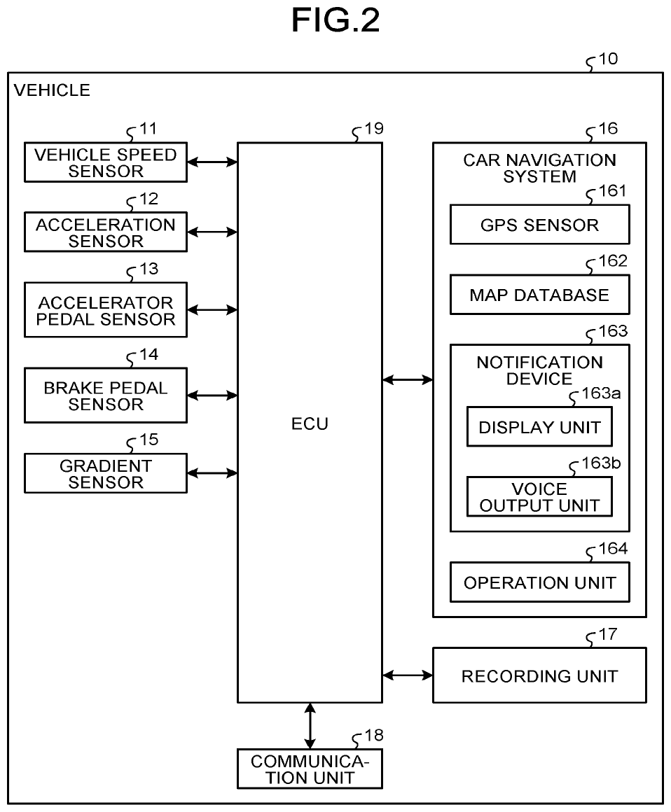

First, a functional configuration of the vehicle 10 will be described. FIG. 2 is a block diagram illustrating a functional configuration of the vehicle 10.

The vehicle 10 illustrated in FIG. 2 includes a vehicle speed sensor 11, an acceleration sensor 12, an accelerator pedal sensor 13, a brake pedal sensor 14, a gradient sensor 15, a car navigation system 16, a recording unit 17, a communication unit 18, and an electronic control unit (ECU) 19. In the following description, the vehicle 10 will be described as an automobile, but is not limited thereto, and may be, for example, a bus or a truck.

The vehicle speed sensor 11 detects a traveling speed (actually measured speed) when the vehicle 10 is traveling, and outputs a detection result to the ECU 19.

The acceleration sensor 12 detects acceleration applied to the vehicle 10 and outputs a detection result to the ECU 19.

The accelerator pedal sensor 13 detects the amount of depression of an accelerator pedal by a user and outputs a detection result to the ECU 19.

The brake pedal sensor 14 detects the amount of depression of a brake pedal by the user and outputs a detection result to the ECU 19.

The gradient sensor 15 detects an inclination of the vehicle 10 (a gradient of the road on which the vehicle 10 travels) with respect to the horizontal, and outputs a detection result to the ECU 19.

The car navigation system 16 includes a global positioning system (GPS) sensor 161, a map database 162, a notification device 163, and an operation unit 164.

The GPS sensor 161 receives signals from a plurality of GPS satellites or transmitting antennas, and calculates a position (longitude and latitude) of the vehicle 10 based on the received signals. The GPS sensor 161 is configured by using a GPS receiving sensor or the like. Note that in the first embodiment, an orientation accuracy of the vehicle 10 may be improved by mounting a plurality of GPS sensors 161.

The map database 162 records various map data. The map database 162 is configured by using a recording medium such as a hard disk drive (HDD) or a solid state drive (SSD).

The notification device 163 includes a display unit 163a for displaying image, map, video, and character information, and a voice output unit 163b for generating sound such as voice or alarm sound. The display unit 163a is configured by using a display such as a liquid crystal or an organic electro luminescence (EL). The voice output unit 163b is configured by using a speaker or the like.

The operation unit 164 receives an input of the user's operation and outputs signals corresponding to the various received operation contents to the ECU 19. The operation unit 164 is realized by using a touch panel, a button, a switch, a jog dial and the like.

The car navigation system 16 configured in this way notifies the user of information including a currently traveling road of the vehicle 10 and a route to a target value by the display unit 163a and the voice output unit 163b by superimposing the current position of the vehicle 10 acquired by the GPS sensor 161 on the map corresponding to the map data recorded by the map database 162.

The recording unit 17 records various information about the vehicle 10. The recording unit 17 records the CAN data of the vehicle 10 input from the ECU 19 and various programs executed by the ECU 19. The recording unit 17 is realized by using a dynamic random access memory (DRAM), a read only memory (ROM), a flash memory, a hard disk drive (HDD), a solid state drive (SSD), and the like.

The communication unit 18 transmits the CAN data and the like to the flood detection device 20 through the network NW under the control of the ECU 19. In addition, the communication unit 18 communicates with any of the other vehicle 10, the map device 30, and the flood display device 40 through the network NW, and receives various information. The communication unit 18 is configured by using a communication module or the like capable of transmitting and receiving various information.

The ECU 19 is configured by using a processor having hardware such as a memory and a central processing unit (CPU). The ECU 19 controls each unit of the vehicle 10. The ECU 19 causes the communication unit 18 to transmit the CAN data of the vehicle 10. The CAN data includes traveling state data such as a traveling speed (actually measured speed), acceleration, a depression amount of an accelerator pedal, a depression amount of a brake pedal, and an inclination of the vehicle 10, time information when the traveling state data is detected, position information (longitude and latitude information) of the vehicle 10, vehicle type information of the vehicle 10, identification information (vehicle ID) for identifying the vehicle 10 and the like. The CAN data may include image data or the like generated by an imaging device provided in the vehicle 10.

Configuration of Flood Detection Device

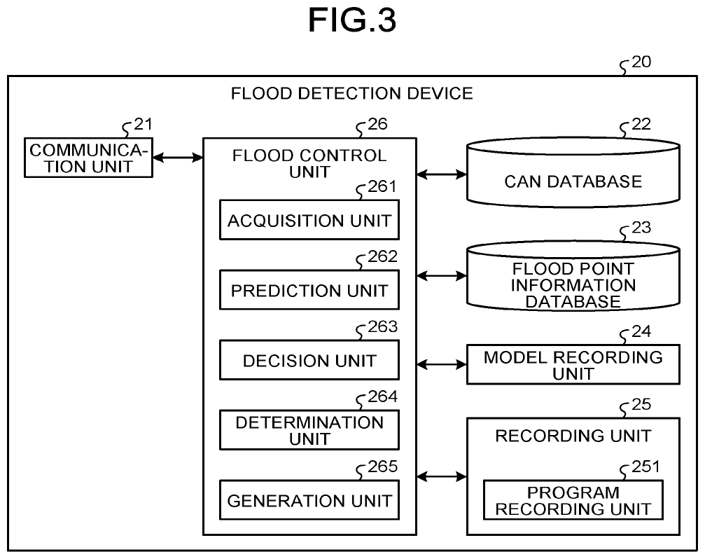

Next, a functional configuration of the flood detection device 20 will be described. FIG. 3 is a block diagram illustrating a functional configuration of the flood detection device 20.

The flood detection device 20 illustrated in FIG. 3 includes a communication unit 21, a CAN database 22, a flood point information database 23, a model recording unit 24, a recording unit 25, and a flood control unit 26.

Under the control of the flood control unit 26, the communication unit 21 receives CAN data transmitted from each of the plurality of vehicles 10 through the network NW, and outputs the received CAN data to the flood control unit 26. In addition, the communication unit 21 transmits flood point information to the map device 30 and the flood display device 40 through the network NW under the control of the flood control unit 26. The communication unit 21 is realized by using a communication module or the like that receives various information. The details of the flood point information will be described later.

The CAN database 22 records the CAN data of each of the plurality of vehicles 10 input from the flood control unit 26. The CAN database 22 is realized by using a hard disk drive (HDD), a solid state drive (SSD) or the like.

The flood point information database 23 records the flood point information indicating a detection result that the flood control unit 26, which will be described later, determines and detects the flood for each divided region based on the CAN data. The flood point information database 23 is realized by using an HDD, an SSD and the like.

The model recording unit 24 uses the CAN data of the vehicle 10 as input data, and records a learned model for outputting the predicted speed from a current position of the vehicle 10 to passing a predetermined distance as an inference result as output data. The learned model is formed by using, for example, a deep neural network (DNN) as machine learning. The type of DNN network may be any one that can be used in the CAN data by the flood control unit 26, which will be described later, and there is no particular need to limit the type.

The recording unit 25 records various information of the flood detection device 20 and data during processing. The recording unit 25 has a program recording unit 251 that records various programs executed by the flood detection device 20. The recording unit 25 is configured by using a dynamic random access memory (DRAM), a read only memory (ROM), a flash memory, an HDD, an SSD and the like.

The flood control unit 26 controls each unit of the flood detection device 20. The flood control unit 26 is configured by using a memory and a processor having hardware such as a graphics processing unit (GPU), a field-programmable gate array (FPGA), and a CPU. The flood control unit 26 includes an acquisition unit 261, a prediction unit 262, a decision unit 263, a determination unit 264, and a generation unit 265. Note that in the first embodiment, the flood control unit 26 functions as a first processor.

The acquisition unit 261 acquires the CAN data from each vehicle 10 through the network NW and the communication unit 21, and records the acquired CAN data in the CAN database 22.

The prediction unit 262 estimates a predicted speed on the road from the current position to a position where the vehicle 10 passes after a predetermined time elapses, based on the CAN data of the vehicle 10 and the learned model recorded by the model recording unit 24. Note that the type of machine learning is not particularly limited, but for example, teacher data and learning data that link the traveling state data and the predicted speed are prepared, and the teacher data and the learning data may be input to a calculation model based on a multi-layer neural network and may be learned. Further, as a method of machine learning, a method based on a deep neural network (DNN) of a multi-layer neural network such as a convolutional neural network (CNN) or a 3D-CNN is used. Further, when targeting time-series data that is continuous in time, such as the traveling state data, as the method of machine learning, a method based on a recurrent neural network (RNN) or a long short-term memory units (LSTM) which is an extension of the RNN is used.

The decision unit 263 detects the flood point of the road by deciding whether the road on which vehicle 10 travels is flooded based on the actually measured speed included in the CNA data of vehicle 10 and the predicted speed of vehicle 10 estimated by the prediction unit 262 for each of the plurality of division regions (each mesh) divided based on latitude and longitude. Specifically, the decision unit 263 decides for each of the division regions whether a difference between the actually measured speed and the predicted speed is equal to or greater than a preset threshold value. Then, the decision unit 263 detects the flood point of the road by deciding that the flood has occurred in a division region where the difference between the actually measured speed and the predicted speed is equal to or greater than the preset threshold value. More specifically, the decision unit 263 decides that the flood has occurred in the road in the division region (traveling section) in which the difference between the actually measured speed and the predicted speed continues for a predetermined time (for example, 5 seconds or more) in a state of being equal to or greater than the preset threshold value. Here, as the threshold value, the difference between the actually measured speed and the predicted speed is set to 15% or more.

The determination unit 264 determines a classification of a flood situation of the flood point based on the CAN data of the vehicle 10 recorded by the CAN database 22 as the CAN data of the vehicle 10 traveling on the flood point detected by the decision unit 263. Here, the classification of the flood situation includes at least one of a reliability of the detection result of the flood point and a flood scale of the flood point.

The reliability of the detection result of the flood point is a value (level) based on the probability that the flood has occurred. Specifically, the determination unit 264 performs determination by calculating the reliability of the detection result of the flood point in the division region determined by the decision unit 263 to be flooded based on the difference between the actually measured speed of the CAN data of the vehicle 10 traveling in the division region determined by the decision unit 263 to be flooded and the predicted speed of the vehicle 10 predicted by the prediction unit 262. For example, the determination unit 264 performs the determination by determining that the probability of flood is low (determines that the probability is 0% to 30%) and calculating the reliability of the detection result of the flood point as “1” (or “small”) if the difference between the measured speed and the predicted speed is 15% to 30%, determining that the probability of flood is medium (determines that the probability is 30% to 60%) and calculating the reliability of the detection result of the flood point as “2” (or “medium”) if the difference between the measured speed and the predicted speed is 30% to 60%, and determining that the probability of flood is low (determines that the probability is 60% to 100%) and calculating the reliability of the detection result of the flood point as “3” (or “large”) if the difference between the measured speed and the predicted speed is 60% to 100%.

The flood scale of the flood point is a value based on at least one of the region (distance×width) of the flood point and a depth (deepness) of the flood point. For example, the flood scale of the flood point includes a large-scale flood (long distance and wide) of deep depth, a large-scale flood (long distance and wide) of shallow depth, a small-scale flood (short distance and narrow) of deep depth, and a small-scale flood (short distance and narrow) of shallow depth. Therefore, the determination unit 264 determines that the flood is a small-scale (short distance and narrow) and the depth is shallow, and performs the determination by calculating the flood scale of the flood point as “1” if the difference between the actually measured speed and the predicted speed is 15% to 30% and the time of the difference is within a predetermined time (predetermined distance), and determines that the flood is a large-scale and the depth is shallow, and performs the determination by calculating the flood scale of the flood point as “2” if the difference between the actually measured speed and the predicted speed is 15% to 30% and the time of the difference is equal to or greater than a predetermined time (predetermined distance). Further, the determination unit 264 determines that the flood is a small-scale (short distance and narrow) and the depth is deep, and performs the determination by calculating the flood scale of the flood point as “2” if the difference between the actually measured speed and the predicted speed is 30% to 60% and the time of the difference is within a predetermined time (predetermined distance), and determines that the flood is a large-scale (long distance and wide) and the depth is deep, and performs the determination by calculating the flood scale of the flood point as “3” if the difference between the actually measured speed and the predicted speed is 30% to 60% and the time of the difference is equal to or greater than a predetermined time (predetermined distance). Furthermore, the determination unit 264 determines that the flood is a small-scale (short distance and narrow) and the depth is deep, and performs the determination by calculating the flood scale of the flood point as “3” if the difference between the actually measured speed and the predicted speed is 60% to 100% and the time of the difference is within a predetermined time (predetermined distance), and determines that the flood is a large-scale (long distance and wide) and the depth is deep, and performs the determination by calculating the flood scale of the flood point as “4” if the difference between the actually measured speed and the predicted speed is 60% to 100% and the time of the difference is equal to or greater than a predetermined time (predetermined distance).

The generation unit 265 generates flood point information based on at least the reliability of the detection result decided and detected by the decision unit 263 and the detection result calculated by the determination unit 264, and transmits the generated flood point information to the map device 30 through the communication unit 21.

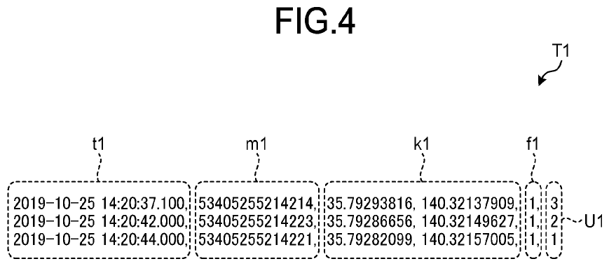

FIG. 4 is a diagram illustrating an example of the flood point information generated by the generation unit 265. The flood point information T1 illustrated in FIG. 4 is associated with detection date and time information t1 that detected the flood, position information m1 of the division region where the flood was detected, longitude and latitude information k1 for the division region where the flood point was detected, a flag f1 indicating the detection result of the flood point, and classification information u1 indicating the classification of the flood situation at the detected flood point. For example, as illustrated in FIG. 4, when the detection date and time information t1 that detected the flood point is “2019-10-25 14:20:37.100”, the position information m1 of the division region where the flood point was detected is associated with “53405255214214”, the longitude and latitude information k1 of the division region where the flood point was detected is associated with “35.79293816,140.32137909”, the flag f1 indicating the detection result of the flood point is associated with “1”, and the reliability of the classification information u1 indicating the classification of the flood situation at the detected flood point is associated with “3”. Note that when the decision unit 263 does not detect the flood, the generation unit 265 generates the flood point information T1 by setting the flag f1 of the detection result of the flood point to “0”. In addition, in FIG. 4, in the flood point information T1, all the flags f1 indicating the detection result of the flood point were “1”, but the flood point information T1 may be generated including the information of the division region where the flood point is not detected by setting the flag f1 to “0”. Further, the generation unit 265 associates the reliability as the classification information u1 indicating the classification of the flood situation at the detected flood point, but may associate the flood scale of the flood point, and may associate the reliability of the detection result of the flood point with the flood scale of the flood point. In this case, for example, when the difference between the actually measured speed and the predicted speed is 60% to 100%, and the determination unit 264 determines the reliability of the detection result of the flood point as “3”, and the flood scale of the flood point as “4”, the generation unit 265 generates the flood point information by associating the reliability of the detection result of the flood point with “3” and the flood scale of the flood point with “4” as the classification information u1 indicating the classification of the flood situation at the detected flood point. In addition, the generation unit 265 numerically represents the reliability of the detection result of the flood point and the flood scale of the flood point as the classification information u1 indicating the classification of the flood situation at the detected flood point, but is not limited thereto, and for example, may represent one value numerically and the other value in alphabets (for example, A to Z) or Greek letters.

Configuration of Map Device

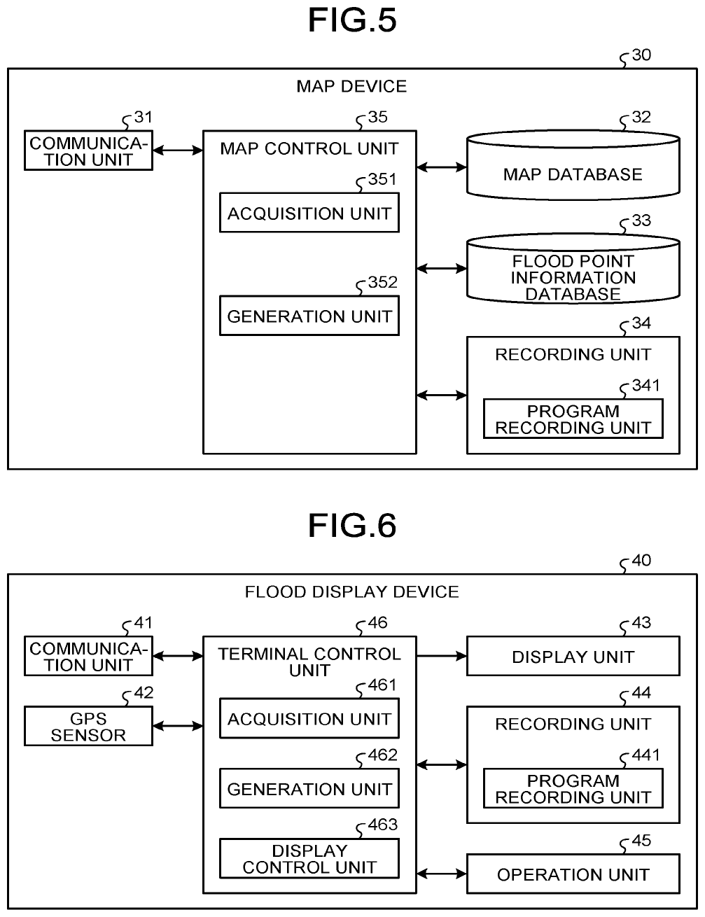

Next, a functional configuration of the map device 30 will be described. FIG. 5 is a block diagram illustrating a functional configuration of the map device 30. In the first embodiment, the map device 30 functions as a server.

The map device 30 illustrated in FIG. 5 includes a communication unit 31, a map database 32, a flood point information database 33, a recording unit 34, and a map control unit 35.

Under the control of the map control unit 35, the communication unit 31 receives the flood point information transmitted from the flood detection device 20 through the network NW, and outputs the flood point information to the map control unit 35. The communication unit 31 is realized by using a communication module or the like that receives various information.

The map database 32 records map data. The map database 32 is configured by using an HDD, an SSD or the like.

The flood point information database 33 records the flood point information input from the map control unit 35. The flood point information database 33 is configured by using an HDD, an SSD or the like.

The recording unit 34 records various information of the map device 30, data during processing and the like. The recording unit 34 has a program recording unit 341 that records various programs executed by the map device 30.

The map control unit 35 controls each unit constituting the map device 30. The map control unit 35 is configured by using a memory and a processor having hardware such as a CPU. The map control unit 35 has an acquisition unit 351 and a generation unit 352. In the first embodiment, the map control unit 35 functions as a second processor.

The acquisition unit 351 acquires the flood point information from the flood detection device 20 through the network NW and the communication unit 31.

The generation unit 352 generates flood detection information based on the map data recorded by the map database 32 and the flood point information recorded by the flood point information database 33. Specifically, the generation unit 352 generates the flood detection information in which the detection result is superimposed on the position on the map corresponding to the map data corresponding to the flood point based on the flood point information.

Configuration of Flood Display Device

Next, a functional configuration of the flood display device 40 will be described. FIG. 6 is a block diagram illustrating a functional configuration of the flood display device 40. The flood display device 40 illustrated in FIG. 6 is realized by using any of a mobile phone, a tablet terminal, a navigation system mounted on the vehicle 10, and the like. In the following, an example in which the mobile phone is used as the flood display device 40 will be described.

As illustrated in FIG. 6, the flood display device 40 includes a communication unit 41, a GPS sensor 42, a display unit 43, a recording unit 44, and a terminal control unit 46.

Under the control of the terminal control unit 46, the communication unit 41 acquires flood detection information from the map device 30 through the network NW. The communication unit 41 is realized by using a communication module or the like that receives various information.

The GPS sensor 42 receives signals from a plurality of GPS satellites or transmitting antennas, and calculates a position (longitude and latitude) of the flood display device 40 based on the received signals. The GPS sensor 42 is configured by using a GPS receiving sensor or the like. Note that in the first embodiment, an orientation accuracy of the flood display device 40 may be improved by mounting a plurality of GPS sensors 42.

Under the control of the terminal control unit 46, the display unit 43 displays an image corresponding to image data, a map having a predetermined scale ratio corresponding to map data, and various GUIs corresponding to application software. The display unit 43 is realized by using a display such as a liquid crystal or an organic EL.

The recording unit 44 records various information regarding the flood display device 40 and data during processing. The recording unit 44 has a program recording unit 441 that records a plurality of programs executed by the flood display device 40. The recording unit 44 is configured by using a recording medium such as a flash memory or a memory card.

An operation unit 45 receives an input of the user's operation and outputs a signal corresponding to the received operation to the terminal control unit 46. The operation unit 45 is realized by using a touch panel, a button, a switch and the like.

The terminal control unit 46 controls each unit of the flood display device 40. The terminal control unit 46 is configured by using a processor having hardware such as a memory and a CPU. The terminal control unit 46 includes an acquisition unit 461, a generation unit 462, and a display control unit 463. In the first embodiment, the terminal control unit 46 functions as a third processor.

The acquisition unit 461 acquires the flood detection information from the flood detection device 20 and the flood detection information from the map device 30 through the network NW and the communication unit 31.

The generation unit 462 generates the flood detection information in which the detection result is superimposed on the position on the map corresponding to the map data corresponding to the flood point based on the flood point information acquired by the acquisition unit 461 from the map device 30.

The display control unit 463 outputs the flood detection information acquired by the acquisition unit 461 from the map device 30 to the display unit 43 to display the flood detection information. Further, the display control unit 463 controls a display mode of the detection result in the flood detection information displayed by the display unit 43 based on the reliability included in the flood point information acquired by the acquisition unit 461 from the flood detection device 20. Specifically, the display control unit 463 performs control to emphasize the detection result of the flood point and display the emphasized detection result on the display unit 43 as the reliability increases. For example, the display control unit 463 performs control to display the detection result of the flood point on the display unit 43 by an icon, a heat map, a graphic, a character or the like based on the reliability included in the flood point information acquired by the acquisition unit 351 from the flood detection device 20, and to emphasize the detection result of the flood point and display the emphasized detection result on the display unit 43 based on the reliability.

Processing of Flood Display System

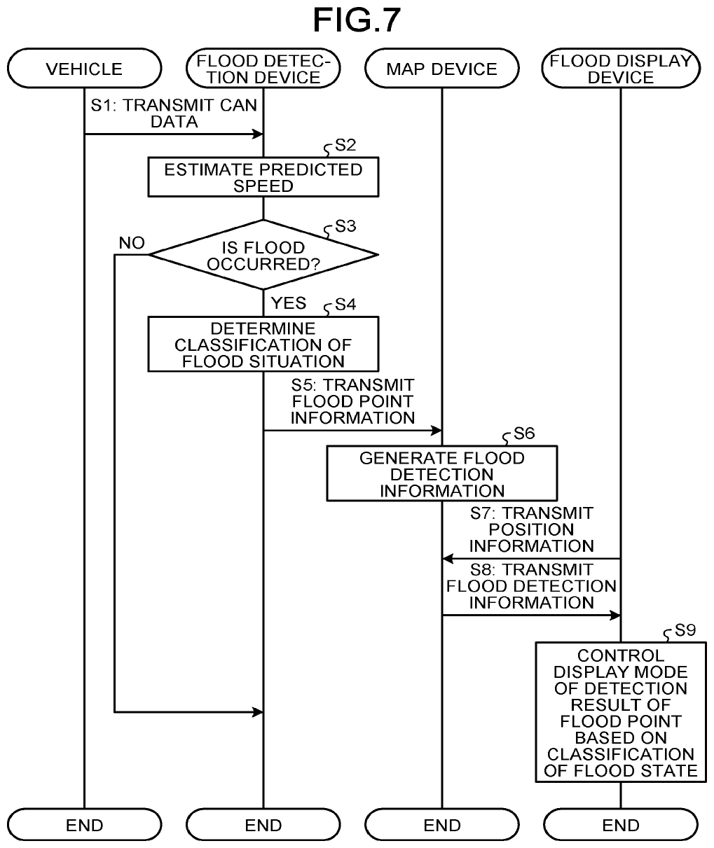

Next, the processing executed by the flood display system 1 will be described. FIG. 7 is a flowchart illustrating an outline of the processing executed by the flood display system 1.

As illustrated in FIG. 7, first, the vehicle 10 transmits the CAN data to the flood detection device 20 (step S1). In this case, the flood control unit 26 of the flood detection device 20 records the CAN data transmitted from each vehicle 10 through the communication unit 21 in the CAN database 22.

Subsequently, the prediction unit 262 of the flood detection device 20 estimates the predicted speed of the vehicle 10 for each of the plurality of division regions based on the CAN data recorded by the CAN database 22 for each of the plurality of division regions divided for each predetermined latitude and longitude and the learned model recorded by the model recording unit 24 (step S2). Specifically, the prediction unit 262 of the flood detection device 20 estimates the predicted speed on the road from the current position to the position where the vehicle 10 passes after a predetermined time elapses for each of the plurality of division regions based on the CAN data of the vehicle 10 and the learned model.

Thereafter, the decision unit 263 of the flood detection device 20 decides whether the flood occurs on the road in the division region on which the vehicle 10 travels based on the predicted speed of the vehicle 10 estimated by the prediction unit 262 and the actually measured speed of the vehicle 10 included in the CAN data (step S3). Specifically, the decision unit 263 detects the flood point of the road by deciding for each of the division regions whether the difference between the actually measured speed and the predicted speed is equal to or greater than a preset threshold value, and deciding that flood has occurred on the road in the division region where the difference between the actually measured speed and the predicted speed is equal to or greater than the preset threshold value. When the decision unit 263 decides that the flood has occurred on the road in the division region where the vehicle 10 travels (step S3: Yes), the flood display system 1 proceeds to step S4 described later. On the other hand, when the decision unit 263 decides that the flood does not occur on the road in the division region where the vehicle 10 travels (step S3: No), the flood display system 1 ends the processing.

In step S4, the determination unit 264 determines the classification of the flood situation at the flood point in the division region determined by the decision unit 263 to be flooded based on the actually measured speed of the vehicle 10 included in the CAN data of the vehicle 10 recorded by the CAN database 22 and the predicted speed of the vehicle 10 predicted by the prediction unit 262.

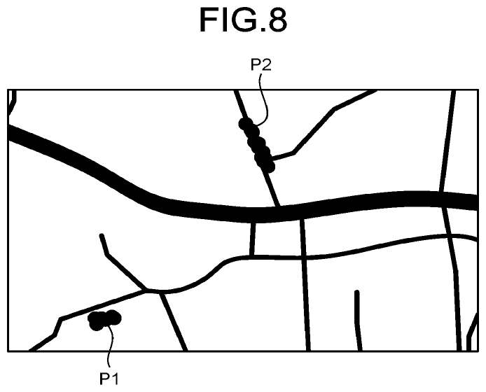

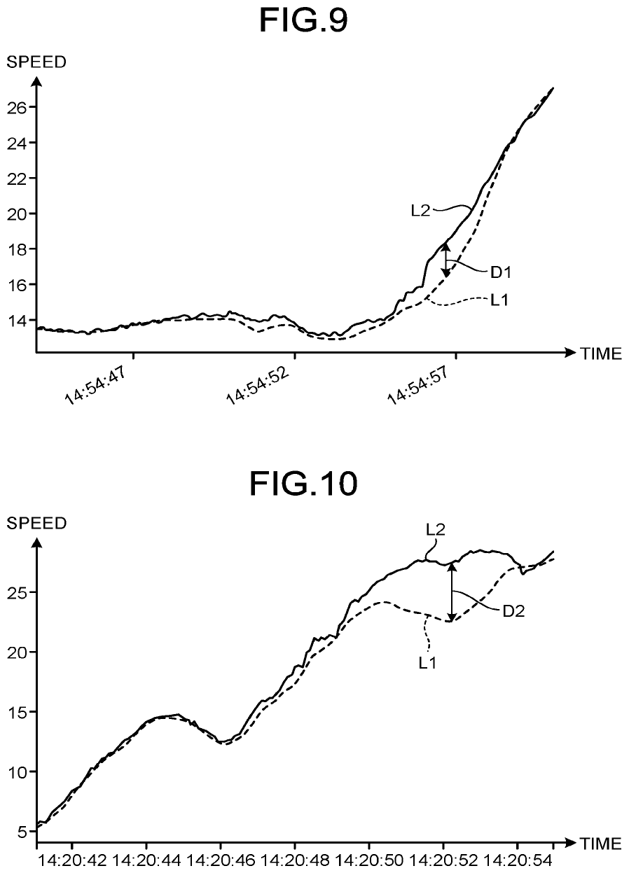

FIG. 8 is a diagram schematically illustrating a flood point. FIG. 9 is a diagram schematically illustrating an actually measured speed of the vehicle 10 and a predicted speed predicted by the prediction unit 262 at the flood point P1 of FIG. 8. FIG. 10 is a diagram schematically illustrating an actually measured speed of the vehicle 10 and a predicted speed predicted by the prediction unit 262 at the flood point P2 of FIG. 8. In FIGS. 9 and 10, a horizontal axis represents time and a vertical axis represents a speed. Further, in FIG. 9, a curve L1 represents a time course of the actually measured speed, and a curve L2 represents a time course of the predicted speed. Further, in FIG. 10, a curve L11 represents a time course of the actually measured speed, and a curve L12 represents a time course of the predicted speed.

As illustrated in the curves L1 and L2 of FIGS. 8 and 9, when the difference D1 between the predicted speed and the actually measured speed at the flood point P1 is small, for example, the difference between the actually measured speed and the predicted speed is 15% to 30%, the determination unit 264 determines the reliability of the detection result as “1” (reliability is “small”). On the other hand, as illustrated in the curves L11 and L12 of FIGS. 8 and 10, when the difference D2 between the predicted speed and the actually measured speed at the flood point P2 is large, for example, the difference between the actually measured speed and the predicted speed is 60% to 100%, the determination unit 264 determines the reliability of the detection result as “3” (reliability is “large”). Note that in FIGS. 8 to 10, the reliability of the detection result of the flood point is determined by calculating in three stages, but is not limited thereto, and the reliability may be determined by calculating in three or more stages, for example, five stages.

In addition, in FIGS. 8 to 10, the method in which determination unit 264 determines the reliability of the detection result of the flood point as the classification of the flood situation at the flood point is described, but is not limited thereto, and the same determination method is used even for the flood scale in the flood point.

For example, the determination unit 264 determines that the flood is a small-scale (short distance and narrow) and the depth is shallow, and determines the flood scale of the flood point as “1” if the difference between the actually measured speed and the predicted speed is 15% to 30% and the time of the difference is within a predetermined time (predetermined distance), and determines that the flood is a large-scale and the depth is shallow, and determines the flood scale of the flood point as “2” if the difference between the actually measured speed and the predicted speed is 15% to 30% and the time of the difference is equal to or greater than a predetermined time (predetermined distance). Further, the determination unit 264 determines that the flood is a small-scale (short distance and narrow) and the depth is deep, and determines the flood scale of the flood point as “2” if the difference between the actually measured speed and the predicted speed is 30% to 60% and the time of the difference is within a predetermined time (predetermined distance), and determines that the flood is a large-scale (long distance and wide) and the depth is deep, and determines the flood scale of the flood point as “3” if the difference between the actually measured speed and the predicted speed is 30% to 60% and the time of the difference is equal to or greater than a predetermined time (predetermined distance). Furthermore, the determination unit 264 determines that the flood is a small-scale (short distance and narrow) and the depth is deep, and determines the flood scale of the flood point as “3” if the difference between the actually measured speed and the predicted speed is 60% to 100% and the time of the difference is within a predetermined time (predetermined distance), and determines that the flood is a large-scale (long distance and wide) and the depth is deep, and determines the flood scale of the flood point as “4” if the difference between the actually measured speed and the predicted speed is 60% to 100% and the time of the difference is equal to or greater than a predetermined time (predetermined distance).

Returning to FIG. 7, a description after step S5 is continued. In step S5, the generation unit 265 of the flood detection device 20 generates the flood point information in which detection date and time information t1 that detected the flood point, position information m1 of the division region where the flood was detected, longitude and latitude information k1 for the division region where the flood point was detected, a flag f1 indicating the detection result of the flood point, and classification information u1 of the detected flood point are associated with each other, and transmits the flood point information to the map device 30. Specifically, the generation unit 265 generates the flood point information T1 in FIG. 4 and transmits the flood point information T1 to the map device 30.

Thereafter, the generation unit 352 of the map device 30 generates flood detection information in which the detection result of flood detection is superimposed on the position on the map corresponding to the map data recorded by the map database 32 based on the flood point information transmitted from the flood detection device 20 (step S6).

Subsequently, the flood display device 40 transmits the position information of the flood display device 40 detected by the GPS sensor 42 to the map device 30 (step S7).

Thereafter, the map control unit 35 of the map device 30 transmits the flood detection information within a predetermined range including the position information of the flood display device 40 to the flood display device 40 based on the position information input from the flood display device 40 (step S8).

Subsequently, the display control unit 463 of the flood display device 40 displays the flood detection information transmitted from the map device 30 on the display unit 43, and controls the display mode of the detection result of the flood detection information based on the classification of the flood situation included in the flood detection information (step S9).

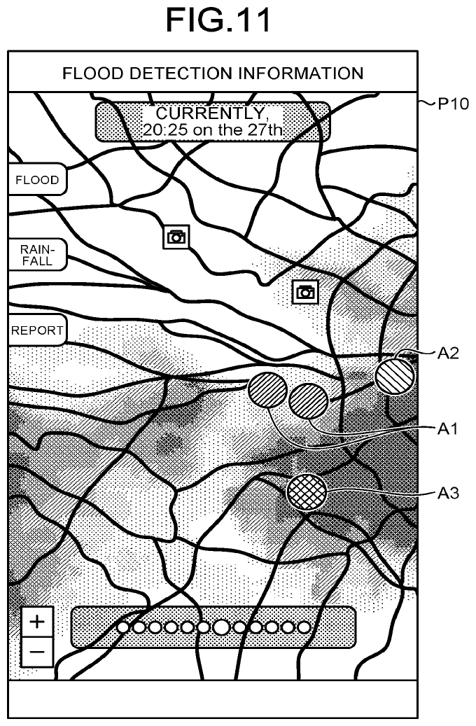

FIG. 11 is a diagram illustrating an example of flood detection information displayed by the flood display device 40. As illustrated in FIG. 11, the display control unit 463 of the flood display device 40 displays the flood detection information P10 transmitted from the map device 30 on the display unit 43. Further, the display control unit 463 of the flood display device 40 controls a display mode of the detection result of the flood point included in the flood detection information transmitted from the map device 30 based on the classification of the flood situation at the flood point included in the flood detection information. Specifically, as illustrated in FIG. 11, the display control unit 463 of the flood display device 40 displays the detection result included in the flood detection information transmitted from the map device 30 on the display unit 43 by icons A1 to A3 based on the reliability of the detection result of the flood point included in the flood detection information. More specifically, the display control unit 463 of the flood display device 40 performs control to emphasize display modes of the icons A1 to A3 and display the emphasized display modes on the display unit 43, as the reliability of the detection result of the flood point increases. For example, when the reliability of the icons A1 to A3 is “3”, “2”, and “1”, the display control unit 463 of the flood display device 40 emphasizes the display modes of the icons A1 to A3 in the order of “red”, “orange”, “yellow”, and the like and displays the emphasized display modes on the display unit 43. Note that the display control unit 463 of the flood display device 40 may display all the icons A1 to A3 in the same color, for example, yellow on the display unit 43, and may add characters or comments to the icons A1 to A3 and display the icons A1 to A3 on the display unit 43 according to the reliability of the detection result. Specifically, the display control unit 463 of the flood display device 40 writes “large flood probability” when the reliability of the detection result is “3”, “medium flood probability” when the reliability of the detection result is “2”, and “small flood probability” when the reliability of the detection result is “1”, and displays these flood probabilities on the display unit 43. In addition, in FIG. 11, the display control unit 463 of the flood display device 40 displays the detection result of the flood point on the display unit 43 by the icons A1 to A3, but may display the detection result of the flood point on the display unit 43 by, for example, a heat map according to the reliability of the detection result of the flood point. As a result, the user can intuitively grasp the flood situation of the flood point. After step S9, the flood display system 1 ends the processing.

Note that in FIG. 11, the display control unit 463 of the flood display device 40 controls the display mode of the detection result of the flood point included in the flood detection information transmitted from the map device 30 based on the reliability of the detection result of the flood point in the classification of the flood situation, but may control the display mode of the detection result of the flood point included in the flood detection information transmitted from the map device 30 based on the flood scale at the flood point in the classification of the flood situation. For example, when the flood scales of the flood points of the icons A1 to A3 are “3”, “2”, and “1”, the display control unit 463 of the flood display device 40 emphasizes the display modes of the icons A1 to A3 in the order of “red”, “orange”, “yellow”, and the like and displays the emphasized display modes on the display unit 43 in the same manner as the reliability. Further, the display control unit 463 of the flood display device 40 may change a size of a display region of the icons A1 to A3 and a color painting range of the icons A1 to A3 based on the flood scale (depth and region) of the flood point.

Furthermore, the display control unit 463 of the flood display device 40 may control the display modes of the icons A1 to A3 by combining the flood scale of the flood point and the reliability of the detection result of the flood point. For example, when the flood scale of the flood point is “3” and the reliability of the detection result of the flood point is “3”, the display control unit 463 of the flood display device 40 displays the display mode of the icon in “dark red” based on the reliability of the detection result of the flood point, and may highlight the icon by enlarging the display region of the icon or changing the shape and display wording of the icon based on the flood scale of the flood point.

According to the first embodiment described above, the terminal control unit 46 of the flood display device 40 acquires the flood point information in which the detection result of the flood point of the road and the classification of the flood situation at the flood point determined based on the traveling state data of the vehicle 10 traveling on the detected flood point are associated with each other, based on the traveling state data related to the traveling of the vehicle 10. Then, the terminal control unit 46 of the flood display device 40 displays the flood detection information in which the detection result indicating that the flood is detected is superimposed on the position on the map corresponding to the flood point on the display unit 43 based on the flood point information, and changes the display mode of the detection result based on the classification of the flood situation at the flood point. Therefore, the user can grasp the flood situation of the flood point in more detail, and can improve the usability for the user.

In addition, according to the first embodiment, as any one of the reliability of the detection result of the flood point and the flood scale of the flood point included in the flood point information is greater, the terminal control unit 46 of the flood display device 40 highlights the detection result of the flood point on the map displayed on the display unit 43. Therefore, the user can intuitively grasp the flood situation of the flood point.

In addition, according to the first embodiment, as any one of the reliability of the detection result of the flood point and the flood scale of the flood point included in the flood point information is greater, the terminal control unit 46 of the flood display device 40 enlarges the display region of the icons A1 to A3 indicating the detection result of the flood point on the map displayed by the display unit 43 and displays the enlarged display region on the display unit 43. Therefore, the user can intuitively grasp the flood situation of the flood point.

In addition, according to the first embodiment, the flood control unit 26 of the flood detection device 20 acquires the traveling state data related to the traveling of the vehicle 10. Then, the flood control unit 26 of the flood detection device 20 determines whether a flood point has occurred on the road based on the traveling state data of the vehicle 10. Thereafter, the flood control unit 26 of the flood detection device 20 determines the classification of the flood situation at the flood point based on the traveling state data of the vehicle 10 traveling on the flood point determined that the flood point has occurred. Therefore, the flood point can be accurately detected.

In addition, according to the first embodiment, the flood control unit 26 of the flood detection device 20 estimates the predicted speed on the road from the current position to the position where the vehicle 10 passes after a predetermined time elapses based on the traveling state data, and determines the classification of the flood situation based on the difference between the actually measured speed and the predicted speed included in the CAN data. Therefore, it is possible to accurately detect the flood situation of the flood point.

In addition, according to the first embodiment, the map control unit 35 of the map device 30 acquires the flood point information in which the detection result of the flood point of the road and the classification of the flood situation determined based on the traveling state data of the vehicle 10 traveling on the detected flood point are associated with each other from the flood detection device 20, based on the traveling state data related to the traveling of the vehicle 10. Then, the map control unit 35 of the map device 30 generates the flood detection information in which the detection result is superimposed on the position on the map corresponding to the flood point based on the flood point information, and controls the display mode of the detection result based on the classification of the flood situation included in the flood point information. That is, the map control unit 35 of the map device 30 may be provided with the function of the display control unit 463 of the flood display device 40. As a result, the user can grasp the flood situation of the flood point portion.

In addition, according to the first embodiment, the map control unit 35 of the map device 30 acquires the position information related to the current position of the flood display device 40 or the position designated by the user, and transmits the flood detection information including the position information to the flood display device 40. Therefore, it is possible to grasp the flood situation of the flood point at the position desired by the user.

In addition, according to the first embodiment, as any one of the reliability of the detection result of the flood point and the flood scale of the flood point included in the flood point information is greater, the map control unit 35 of the map device 30 highlights the detection result of the flood point on the map to be displayed on the display unit 43 of the flood display device 40. Therefore, the user can intuitively grasp the flood situation of the flood point.

Note that in the first embodiment, the terminal control unit 46 of the flood display device 40 displays the flood detection information in which the detection result indicating that the flood is detected at the position on the map corresponding to the flood point is superimposed on the display unit 43 based on the flood point information, and changes the display mode of the detection result based on the classification of the flood situation at the flood point, but for example, the map control unit 35 of the map device 30 may generate the flood detection information in which the detection result indicating that the flood is detected at the position on the map corresponding to the flood point is superimposed, and may change the display mode of the detection result based on the classification of the flood situation at the flood point.

In addition, in the first embodiment, the map device 30 generates the flood detection information by acquiring the flood detection information from the flood detection device 20, but for example, the flood display device 40 may generate the flood detection information by acquiring the flood point information from the flood detection device 20. For example, the flood point information may be generated by superimposing the detection result of the flood point on a map application of the flood display device 40 (for example, the map corresponding to the map data of the car navigation system 16), and may be output to the display unit 43 (display unit 163a) for display.

### Second Embodiment

Next, a second embodiment will be described. In the first embodiment, the determination unit 264 determines the classification of the flood situation of the flood point based on the difference between the actually measured speed and the predicted speed of the vehicle 10 based on based on the CAN data in a predetermined division region (for example, 16 m×16 m), but in the second embodiment, the determination unit 264 determines the classification of the flood situation at the flood point based on the number of vehicles 10 that have passed the flood point within a predetermined time based on the CAN data at the flood point. In the following, a determination method will be described in which the determination unit determines the classification of the flood situation at the flood point. The same configuration as that of the flood display system 1 according to the first embodiment is designated by the same reference numerals, and detailed description thereof will be omitted.

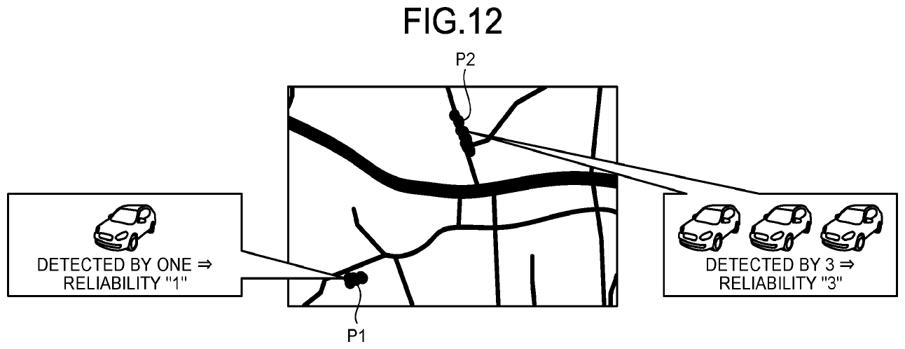

FIG. 12 is a diagram schematically illustrating a method of determining a classification of a flood situation at a flood point determined by a determination unit 264 according to a second embodiment.

As illustrated in FIG. 12, the determination unit 264 determines the classification of the flood situation at the flood point based on the number of vehicles 10 that have passed the flood point decided by the decision unit 263 within a predetermined time. For example, as illustrated in FIG. 12, when determining the reliability of the detection result of the flood point as the classification of the flood situation at the flood point, the determination unit 264 determines the reliability of the detection result of the flood point by calculating the reliability of the detection result of the flood point based on the number of vehicles 10 that have passed the flood point within the predetermined time based on the flood detection information. Specifically, when the number of vehicles 10 that have passed the flood point P1 within the predetermined time is one, the determination unit 264 determines the reliability of the detection result of the flood point by calculating the reliability of the detection result of the flood point as “1” (or the reliability is “small”). On the other hand, when the number of vehicles 10 that have passed the flood point P2 within the predetermined time is three, the determination unit 264 determines the reliability of the detection result of the flood point by calculating the reliability of the detection result of the flood point as “3” (or the reliability is “large”). Note that in addition, in FIG. 12, the method in which determination unit 264 determines the reliability of the detection result of the flood point as the classification of the flood situation at the flood point is described, but is not limited thereto, and the same determination method is used even for the flood scale in the flood point.

According to the second embodiment described above, the flood control unit 26 of the flood detection device 20 determines the classification of the flood situation at the flood point based on the number of vehicles 10 that have passed the flood point within the predetermined time based on the traveling state data of the vehicle 10. Therefore, it is possible to accurately detect the flood situation of the flood point.

### Third Embodiment

Next, a third embodiment will be described. The determination unit according to the third embodiment adds the value calculated based on the difference between the predicted speed and the actually measured speed according to the first embodiment or the number of passing vehicles over time, and determines the value obtained by subtracting an attenuation coefficient from the addition result as the classification of the flood situation at the flood point. In the following, a determination method will be described in which the determination unit determines the classification of the flood situation at the flood point. The same configuration as that of the flood display system 1 according to the first embodiment is designated by the same reference numerals, and detailed description thereof will be omitted.

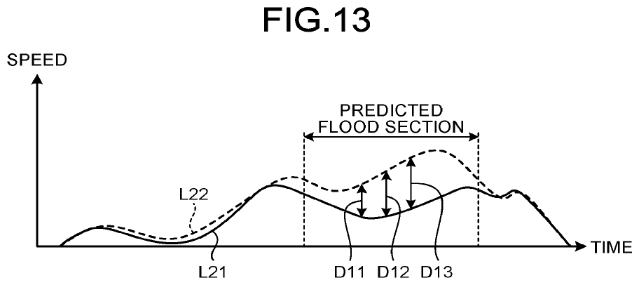

FIG. 13 is a diagram schematically illustrating the actually measured speed of the vehicle 10 in a predicted flood section and a predicted speed predicted by the prediction unit 262. In FIG. 13, a horizontal axis represents time and a vertical axis represents a speed. Further, in FIG. 13, a curve L21 represents a time course of the actually measured speed, and a curve L22 represents a time course of the predicted speed. Note that in the following, a case where the determination unit 264 determines the reliability of the detection result of the flood point as the classification of the flood situation at the flood point will be described.

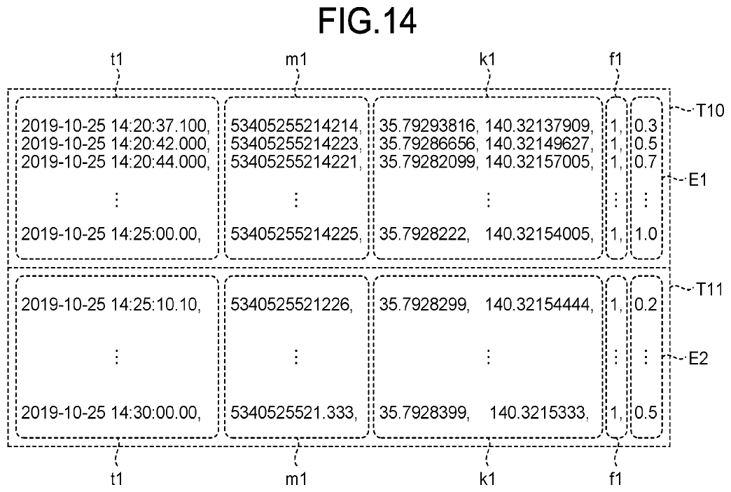

As illustrated in the curves L21 and L22 of FIG. 13, the determination unit 264 determines the reliability of the detection result of the flood point by calculating a larger value of the maximum value among the values D11 to D13 obtained by calculating multiple the difference between the predicted speed and the actually measured speed in the predicted flood section (within a predetermined time) at the flood point in the same division region, and a value based on the number of passing vehicles 10 that have passed within a predetermined time at the flood point in the same division region as the reliability of the detection result of the flood point. Then, the determination unit 264 updates the reliability of the detection result of the flood point by determining the reliability of the detection result of the latest flood point by the same method at predetermined time intervals, adding the determined reliability of the detection result of the latest flood point to the previous reliability of the detection result of the flood point, and subtracting a preset attenuation coefficient. For example, as illustrated in FIG. 14, for example, the determination unit 264 determines the reliability of the detection result of the flood point by subtracting the attenuation coefficient from an addition result obtained by adding the maximum value “1” among the error values El indicating a plurality of differences included in the flood point information T10 in the division region, and the maximum value “0.5” among the error values E2 indicating a plurality of differences included in the flood point information T11 in the division region after 5 minutes. Specifically, the determination unit 264 updates the reliability of the detection result of the flood point by Equation (1) below when the latest error value E2 is “0.5” and the attenuation coefficient is “0.3” when the error value E1 of the previous time (before 5 minutes) is “1”.

1.0−0.3+0.5=1.2 (1)

In this way, the determination unit 264 determines the reliability of the detection result of the flood point over time by determining (calculating) a larger value of the maximum value among the values obtained by determining multiple the difference between the predicted speed and the actually measured speed within a predetermined time at the flood point in the same division region, and a value based on the number of passing vehicles 10 that have passed within a predetermined time at the flood point in the same division region as the reliability of the detection result of the flood point at predetermined time intervals (for example, every 5 minutes), adding the larger value over time, and subtracting the attenuation coefficient for each addition. As a result, the display control unit 463 of the flood display device 40 controls the display mode of the flood point based on the reliability of the detection result of the flood point calculated by the determination unit 264 at predetermined time intervals. As a result, the user can intuitively grasp the change in the flood situation of the flood point that changes over time. Note that the determination unit 264 uses the maximum value among the values obtained by calculating multiple the difference between the predicted speed and the actually measured speed within a predetermined time at the flood point in the same division region for each division region, but is not limited thereto, and may use an average value or a median value of the values obtained by calculating multiple the difference between the predicted speed and the actually measured speed within a predetermined time at the flood point in the division region.

According to the third embodiment described above, the flood control unit 26 of the flood detection device 20 estimates the predicted speed on the road from the current position of the vehicle 10 to the position to be added after the lapse of a predetermined time based on the traveling state data of the vehicle 10. Then, the flood control unit 26 of the flood detection device 20 determines the classification of the flood situation at the flood point based on the value obtained by sequentially adding the larger value of the maximum value of the difference between the actually measured speed and the predicted speed within the predetermined time and the number of vehicles 10 that have passed the flood point within the predetermined time every predetermined time lapse, and subtracting a subtraction coefficient for each addition. Therefore, it is possible to accurately detect the flood situation of the flood point that changes over time.

### Fourth Embodiment

Next, a fourth embodiment will be described. In the fourth embodiment, in addition to the configuration of the flood display system 1 according to the first embodiment described above, the classification of the flood situation at the flood point is determined by further using a difference between a predicted rainfall amount and a road drainage amount of a plurality of flood predicted regions (for example, 10 km×10 km) divided based on the latitude and longitude. In the following, a configuration of the flood display system according to the fourth embodiment will be described. The same configuration as that of the flood display system 1 according to the first embodiment described above is designated by the same reference numerals, and detailed description thereof will be omitted.

Overview of Flood Display System

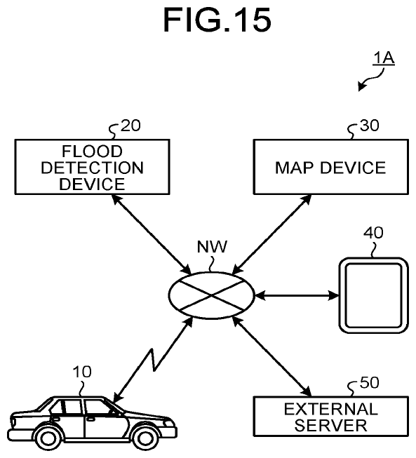

FIG. 15 is a diagram schematically illustrating a configuration of a flood display system according to a fourth embodiment. A flood display system 1A illustrated in FIG. 15 further includes an external server 50 in addition to the configuration of the flood display system 1 according to the first embodiment described above.

The external server 50 generates flood prediction information indicating a plurality of flood prediction regions (for example, 10 km×10 km) in which a difference between a plurality of actual rainfall amounts divided based on latitude and longitude and a road drainage amount on the road on which the vehicle 10 travels is equal to or greater than a predetermined threshold value every predetermined time (for example, every 5 minutes), and transmits the flood prediction information to the flood detection device 20. The external server 50 is configured by using a memory and a processor having hardware such as a CPU.

In the flood display system 1A configured in this way, the determination unit 264 of the flood detection device 20 determines the flood situation in the division region detected by the decision of the decision unit 263 based on the flood prediction information transmitted from the external server 50 and the traveling state data of the vehicle 10. Specifically, the determination unit 264 determines whether the flood prediction region included in the flood prediction information transmitted from the external server 50 includes the flood point in the division region detected by the decision of the decision unit 263, and determines the classification of the flood situation in the flooded region when the flood prediction region includes the flooded point. In this case, the determination unit 264 may change the range of reliability of the detection result of the flood point based on the difference between the actual rainfall data included in the rainfall prediction information and the road drainage amount. Then, the display control unit 463 of the flood display device 40 controls the display mode of the detection result of the flood point based on the classification of the flood situation at the flood point to which the flood prediction information calculated by the determination unit 264 at predetermined time intervals is added. As a result, the user can intuitively grasp the change in the flood situation of the flood point that changes over time. In addition, the decision unit 263 may change the threshold value for deciding the flood point based on the flood prediction information. Specifically, the decision unit 263 may change the threshold value for deciding and detecting the flood point based on the difference between the actual rainfall amount data and the road drainage amount. For example, the decision unit 263 increases the threshold value for deciding and detecting the flood point because it is assumed that the smaller the difference between the actual rainfall amount data and the road drainage amount, the smaller an actual drainage amount of the road.

According to the fourth embodiment described above, the flood control unit 26 of the flood detection device 20 acquires the flood prediction information from the external server 50 based on the actual rainfall amount in the area where the vehicle 10 travels and the road drainage amount on the road on which the vehicle 10 travels. Then, the flood control unit 26 of the flood detection device 20 further uses the flood prediction information to decide the classification of the flood situation at the flood point. Therefore, it is possible to accurately detect the flood situation of the flood point that changes over time.

### Other Embodiments

In addition, in the flood display system according to the first to fourth embodiments, the classification of the flood situation at the flood point is the reliability of the detection result of the flood point and the flood scale of the flood point, but is not limited thereto, and various information can be applied even if it is not the reliability of the detection result of the flood point and the flood scale of the flood point. For example, the classification of the flood situation at the flood point includes a flood frequency and a flood time of the flood point. For example, in the case of flood frequency, the flood detection device records the flood points where the flood was detected in the past in the flood point information database, and the map device may generate the flood detection information such as highlighting in red in the case of a flood point in which the flood is detected a predetermined number of times or more (for example, 5 times or more in the last 3 months) in a predetermined period including the latest detection, displaying in orange when the flood is 2 times or more to less than 5 times in the last 3 months, and displaying in yellow when there is no flood record within the last 3 months and it is the first time, and may transmit the flood detection information to the flood display device. In addition, in the case of flood time, the flood detection device records the time from a time point when the flood is firstly detected on the same day to a time point when the flood is lastly detected in the flood point information database, and the map device may generate the flood detection information such as highlighting a flood point where the flood has been detected continuously for 10 hours or more from the time when the flood was firstly detected on the same day to the latest detection in red, displaying in orange when the flood is 5 hours or more and less than 10 hours, and displaying in yellow when the flood is one hour or more and less than 5 hours, and may transmit the flood detection information to the flood display device.

In addition, in the flood display system according to the first to fourth embodiments, “unit” can be read as “circuit” or the like. For example, the control unit can be read as a control circuit.

The programs to be executed by the flood display system according to the first to fourth embodiments are provided by being recorded on a computer-readable recording medium such as a CD-ROM, a flexible disk (FD), a CD-R, a digital versatile disk (DVD), an USB medium, or flash memory as file data in an installable format or an executable format.

In addition, the programs to be executed by the flood display system according to the first to fourth embodiments may be stored on a computer connected to a network such as the Internet and provided by being downloaded via the network.

In the description of the flowchart in the present specification, the context of the processing between steps is clarified by using expressions such as “first”, “after”, and “continued”, but the order of processing required to implement the present embodiment is not uniquely defined by those expressions. That is, the order of processing in the flowchart described in the present specification can be changed within a consistent range.

According to the present disclosure, it is possible to improve the usability for the user.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A flood display device comprising:
a processor with hardware, wherein
the processor is configured to:
acquire flood point information in which a detection result of a flood point of a road and a classification of a flood situation at the flood point determined based on traveling state data of a vehicle traveling at the detected flood point are associated with each other based on the traveling state data related to the traveling of the vehicle,
generate flood detection information in which a display mode of the detection result is changed based on the classification of the flood situation as flood detection information obtained by superimposing the detection result on a position on a map corresponding to the flood point based on the flood point information, and
output the flood detection information to a display.

2. The flood display device according to claim 1, wherein
the classification of the flood situation includes at least one of a reliability of the detection result and a flood scale of the flood point.

3. The flood display device according to claim 2, wherein
the processor emphasizes the detection result as at least one of the reliability and the flood scale is increased.

4. The flood display device according to claim 2, wherein
the processor is configured to:
display the detection result by using an icon, and
increase a display region of the icon on the map as at least one of the reliability and the flood scale is increased.

5. A flood detection device comprising:
a processor with hardware, wherein
the processor is configured to:
acquire traveling state data related to a traveling of a vehicle,
detect whether a flood point has occurred on a road based on the traveling state data, and
determine a classification of a flood situation in the detected flood point based on the traveling state data of the vehicle traveling on the detected flood point.

6. The flood detection device according to claim 5, wherein
the classification of the flood situation includes at least one of a reliability of a detection result of the flood point and a flood scale of the flood point.

7. The flood detection device according to claim 6, wherein
the traveling state data includes an actually measured speed of the vehicle,
the processor is configured to:
estimate a predicted speed on a road from a current position to a position where the vehicle passes after a predetermined time has elapsed based on the traveling state data, and
determine at least one of the reliability and the flood scale based on a difference between the actually measured speed and the predicted speed.

8. The flood detection device according to claim 6, wherein
the processor is configured to determine the reliability and the flood scale based on a number of vehicles that have passed the flood point within a predetermined time based on the traveling state data of the vehicles traveling on the detected flood point.

9. The flood detection device according to claim 6, wherein
the traveling state data includes an actually measured speed of the vehicle,
the processor is configured to:
estimate a predicted speed on a road from a current position to a position to be passed by the vehicle after a predetermined time has elapsed based on the traveling state data of the vehicle traveling on the detected flood point, and
determine at least one of the reliability and the flood scale based on a value obtained by sequentially adding a larger value of a maximum value of the difference between the actually measured speed and the predicted speed within a predetermined time and a number of vehicles that have passed the flood point within a predetermined time based on the traveling state data of the vehicles traveling on the detected flood point for each predetermined time, and subtracting a subtraction coefficient for each addition.

10. The flood detection device according to claim 6, wherein
the processor is configured to:
acquire flood prediction information from an external server based on the actual rainfall amount in an area where the vehicle travels and a road drainage amount on the road on which the vehicle travels, and
determine at least one of the reliability and the flood scale by further using the flood prediction information.

11. The flood detection device according to claim 10, wherein
the processor is configured to:
determine whether the area included in the flood prediction information includes the flood point which is detected as the flood point has occurred, and
determine at least one of the reliability and the flood scale when it is determined that the flood point detected that the flood point has occurred is included in the area included in the flood prediction information.

12. The flood detection device according to claim 5, wherein
the processor is configured to:
generate flood point information in which at least the detection result of the flood point and the classification of the flood situation at the flood point are associated with each other, and
transmit the flood point information to a server that records map data.

13. A server comprising:
a processor with hardware, wherein
the processor is configured to:
acquire flood point information in which a detection result of a flood point of a road and a classification of a flood situation at the flood point determined based on traveling state data of a vehicle traveling at the detected flood point are associated with each other based on the traveling state data related to the traveling of the vehicle,
generate flood detection information in which a display mode of the detection result is changed based on the classification of the flood situation as flood detection information obtained by superimposing the detection result on a position on a map corresponding to the flood point based on the flood point information, and
transmit the flood detection information to an external device.

14. The server according to claim 13, wherein
the processor is configured to:
acquire position information related to a current position of the external device or a position designated by a user, and
transmit the flood detection information including the position information to the external device.

15. The server according to claim 13, wherein
the classification of the flood situation includes at least one of a reliability of the detection result and a flood scale of the flood point, and
the detection result is highlighted as at least one of the reliability and the flood scale is increased.

16. A flood display system comprising:
a flood detection device including a first processor with hardware;
a server including a second processor with hardware; and
a flood display device including a third processor with hardware, wherein
the first processor is configured to:
acquire traveling state data related to a traveling of a vehicle,
detect whether a flood point has occurred on a road based on the traveling state data, and
determine a classification of a flood situation at the detected flood point based on the traveling state data of the vehicle traveling on the detected flood point,
the second processor is configured to:
acquire flood point information in which a detection result of the flood point and the classification of the flood situation are associated with each other, and
generate flood detection information in which a display mode of the detection result is changed based on the classification of the flood situation as the flood detection information in which the detection result is superimposed on a position on a map corresponding to the flood point, based on the flood point information, and
the third processor is configured to:
acquire the flood detection information, and
output the flood detection information to a display.

17. A flood display method executed by a flood display device including a processor with hardware, the flood display method comprising:
acquiring, by the processor, flood point information in which a detection result of a flood point of a road and a classification of a flood situation determined based on traveling state data of a vehicle traveling at the detected flood point are associated with each other based on the traveling state data related to the traveling of the vehicle;
generating, by the processor, flood detection information in which a display mode of the detection result is changed based on the classification of the flood situation as flood detection information obtained by superimposing the detection result on a position on a map corresponding to the flood point based on the flood point information; and
outputting, by the processor, the flood detection information to a display.

18. A flood display method executed by a server including a processor with hardware, the flood display method comprising:
acquiring, by the processor, flood point information in which a detection result of a flood point of a road and a classification of a flood situation at the flood point determined based on traveling state data of a vehicle traveling at the detected flood point are associated with each other based on the traveling state data related to the traveling of the vehicle;
generating, by the processor, flood detection information in which a display mode of the detection result is changed based on the classification of the flood situation as flood detection information obtained by superimposing the detection result on a position on a map corresponding to the flood point based on the flood point information; and
transmitting, by the processor, the flood detection information to an external device.

19. A flood detection method executed by a flood detection device including a processor with hardware, the flood detection method comprising:
acquiring, by the processor, traveling state data related to a traveling of a vehicle;
detecting, by the processor, whether a flood point has occurred on a road based on the traveling state data; and
determining, by the processor, a classification of a flood situation in the detected flood point based on the traveling state data of the vehicle traveling on the detected flood point.

20. A non-transitory computer-readable recording medium storing a program for causing a processor with hardware to:
acquire flood point information in which a detection result of a flood point of a road and a classification of a flood situation at the flood point determined based on traveling state data of a vehicle traveling at the detected flood point are associated with each other based on the traveling state data related to the traveling of the vehicle;
generate flood detection information in which a display mode of the detection result is changed based on the classification of the flood situation as flood detection information obtained by superimposing the detection result on a position on a map corresponding to the flood point based on the flood point information; and
output the flood detection information to a display.

21. A non-transitory computer-readable recording medium storing a program for causing a processor with hardware to:
acquire flood point information in which a detection result of a flood point of a road and a classification of a flood situation at the flood point determined based on traveling state data of a vehicle traveling at the detected flood point are associated with each other based on the traveling state data related to the traveling of the vehicle;
generate flood detection information in which a display mode of the detection result is changed based on the classification of the flood situation as flood detection information obtained by superimposing the detection result on a position on a map corresponding to the flood point based on the flood point information; and
transmit the flood detection information to an external device.

22. A non-transitory computer-readable recording medium storing a program for causing a processor with hardware to:
acquire traveling state data related to a traveling of a vehicle;
detect whether a flood point has occurred on a road based on the traveling state data; and
determine a classification of a flood situation in the detected flood point based on the traveling state data of the vehicle traveling on the detected flood point.
